(19) United States
(12) Patent Application Publication
(10) Pub. No.: US 2019/0066161 A1
(43) Pub. Date: Feb. 28, 2019

(54) PREDICTIVE SYSTEM FOR SELECTING GROUPS OF USERS IN CONNECTION WITH A NETWORK SERVICE

(71) Applicant: Uber Technologies, Inc., San Francisco, CA (US)

(72) Inventors: Yefei Peng, Palo Alto, CA (US); James Lee, San Francisco, CA (US); Rui Wang, Fremont, CA (US); Haowei Zhang, Sunnyvale, CA (US); Yi Zheng, Redwood City, CA (US); Erin Wolpert, San Francisco, CA (US)

(21) Appl. No.: 15/865,253

(22) Filed: Jan. 8, 2018

Related U.S. Application Data
(60) Provisional application No. 62/552,374, filed on Aug. 30, 2017.

(51) Int. Cl. G06Q 30/02; G06N 7/00

(52) U.S. Cl. CPC G06Q 30/0269; G06F 7/588; G06N 7/005

(57) ABSTRACT

A network computer system maintains a service profile for each user in a population of users for a network service, where the service profile identifies multiple service parameters, and each service parameter of the service profile is based at least in part on one or more predefined usage events. The network computer system can identify a service signal in connection with providing the network service, where the service signal identifies an intent for a group of users. The network computer system can determine, using the service profile of individual users of the population, a group of users that is likely to include more users that are to perform an action in accordance with the intent of the service signal, as compared to a baseline value.

### RELATED APPLICATIONS

This application claims benefit of priority to Provisional U.S. Application No. 62/552,374, filed on Aug. 30, 2017; the aforementioned application being incorporated by reference in its respective entirety.

### TECHNICAL FIELD

Examples described herein relate to predictive system for selecting groups of users in connection with a network service.

### BRIEF DESCRIPTION OF THE DRAWINGS

FIG. 1A illustrates a service arrangement system, according to one or more examples.

FIG. 1B illustrates a user predictive sub-system, according to one or more examples.

FIG. 2 illustrates an example method for implementing a predictive system to select groups of users with greater propensity for a particular intent.

FIG. 3 is a block diagram that illustrates a computer system upon which embodiments described herein may be implemented.

### DETAILED DESCRIPTION

Examples provide a system to personalize a network experience to users using predictive decision making. In variations, the personalization of the network service can be implemented to be specific for individual users and/or for groups of users. Through predictive decision making, a network service can alter facets of the network service in a manner that enhances user experience, while promoting efficiency of computing resources that are utilized by the network service.

In some examples, a network computer system implements an on-demand service that matches service providers with requesters. The network computer system can select groups of users to receive a particular treatment reflecting a manner in which the network service is provided, By way of example, the network computer system may select a group of users that are expected to have a greater propensity to a predefined intent, in connection with a planned service signal that reflects a treatment which the identified group receives (e.g., product offering, prompt, service application behavior, etc.).

According to some examples, a network computer system maintains a service profile for each user in a population of users for a network service, where the service profile identifies multiple service parameters, and each service parameter of the service profile is based at least in part on one or more predefined usage events. The network computer system can identify a service signal in connection with providing the network service, where the service signal identifies an intent for a group of users. The network computer system can determine, using the service profile of individual users of the population, a group of users that is likely to include more users that are to perform an action in accordance with the intent of the service signal, as compared to a baseline value. In some examples, network computer system maintains a service profile for each user of a population of users. For each user, the network computer system monitors the respective user's utilization of the service, and detects, from monitoring, multiple different usage events. The network computer system maintains and updates the service profile of the respective user based on the detected usage events. The network computer system can identify users in the group who have a propensity to perform a particular action as a response to a given service signal.

As used herein, a user device, a requester device, a provider device, and/or a computing device refer to devices corresponding to desktop computers, cellular devices or smartphones, laptop computers, tablet devices, wearable devices, and other connected devices that can provide network connectivity and processing resources for communicating with a network computer system over a network. A provider device can also correspond to custom hardware, in-vehicle devices, or on-board computers of a vehicle operated by a service provider, etc. The user device and/or the provider device can also operate a respective service application that is configured to communicate with the network computer system, in context of, for example, providing on-demand services.

While some examples described herein relate to on-demand transport services, the service arrangement system can enable other on-demand location-based services (for example, a food truck service, a delivery service, an entertainment service) to be arranged between individuals and service providers. For example, a user can request an on-demand service, such as a delivery service (e.g., food delivery, messenger service, food truck service, or product shipping) or an entertainment service (e.g., mariachi band, string quartet) using the system, and the system can select a service provider, such as a driver, food provider, band, etc., to provide the on-demand service for the user.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

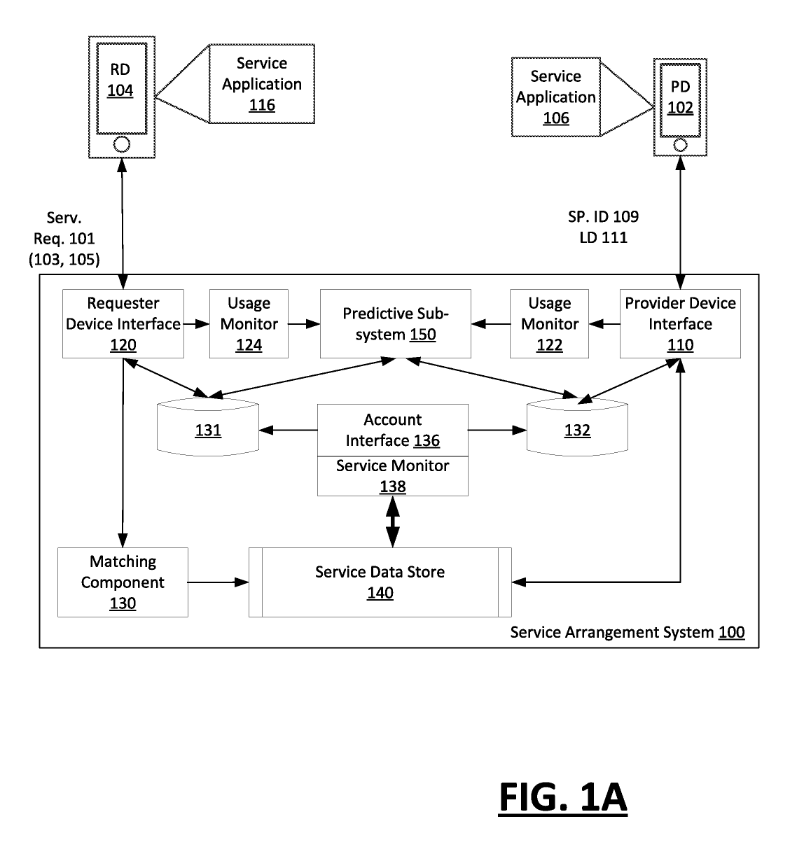

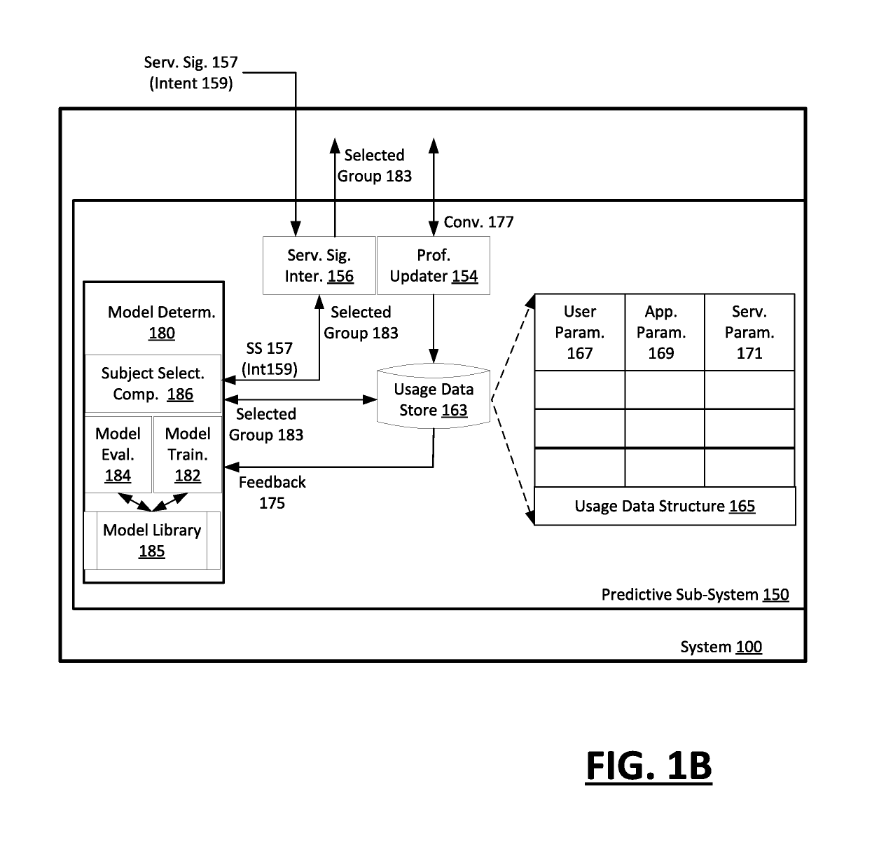

FIG. 1A illustrates a network computer system, such as a service arrangement system, according to one or more examples. As described, a network computer system 100 may be implemented to provide a network service, such as an on-demand transportation service that transports users, and/or delivers products or food to users. Accordingly, the system 100 may be implemented on, for example, one or more servers or other network computer machines. In some examples, the system 100 is implemented as part of a transport arrangement service, which operates to match incoming transport service requests from requester devices with service providers who are available and in proximity to the start location of the service request. In variations, the system 100 can be implemented as a separate or standalone service that can interface with a transportation arrangement service or user device (e.g., via a service application for the network service). Still further, in other variations, the system 100 can be implemented at least in part on individual user devices. For example, functionality described with the system 100 may be implemented as part of a service application that runs on mobile devices 102 of individual service providers.

In an example of FIG. 1A, the system 100 is shown to be in communication with each of a provider device 102 and a requester device 104, representing devices operated by respective provider class users (e.g., drivers) and requester class users (e.g., riders) of a given population. Each provider device 102 and/or requester device 104 operates a corresponding service application 106, 116 implemented through execution of instructions stored in one or more memory resources of the computing device. The service applications 106, 116 may correspond to programs (e.g., a set of instructions or code) or applications (e.g., ‘apps’) that are downloaded and stored on the computing devices of the respective users. With reference to FIG. 1A, the service application 106 executes on the provider device 102 to transmit information that includes the provider's identifier 109 and the provider's current location 111. Likewise, the requester device 104 can execute the service application 116 to communicate the requester's identifier and the requester's current location, such as determined by a location detection component of the requester device 104 (e.g., a global positioning system receiver). Additionally, the requester can operate the requester device 104 to make a service request 101 that specifies service parameters, such as a service start location 103, destination 105, or other parameters (e.g., service type).

In an example of FIG. 1A, the system 100 includes a provider device interface 110, a requester device interface 120, a matching component 130, and a service data store 140. The provider device interface 110 can establish a network connection with the provider device 102, via execution of the corresponding service application 106. The provider device interface 110 may receive provider data (e.g., provider identifier 109, provider's current location 111, etc.) using the network connection. In one implementation, the provider device interface 110 can establish a connection with multiple provider devices 102 concurrently, with the connection to each provider device using one or more wireless networks (e.g., wireless networks, such as a cellular transceiver, a WLAN transceiver, etc.).

Each of the provider and requester device interfaces 110, 120 can include or use an application programming interface (API), such as an externally facing API, to communicate data with one or more provider devices 102 and requester devices 104, respectively. The externally facing API can provide access to the provider device 102 via secure access channels over the network through any number of methods, such as web-based forms, programmatic access via RESTful APIs, Simple Object Access Protocol (SOAP), remote procedure call (RPC), scripting access, etc.

In some examples, a service provider may operate the service application 106 to initiate a service session with the system 100, during which the service provider is available to receive and perform service requests. For example, the service provider may initiate a service session by toggling a user-interface feature of the service application 106. Over the course of a service session, the service provider is available to receive assignments from system 100. In such examples, the time when the service session of the service provider starts and terminates may thus be selected by the service provider.

When the service provider initiates the service session, the service provider's identifier 109 and current location 111 are communicated to the system 100 via the provider device interface 110. The provider device interface 110 may record the service provider identifier 109 and the provider's current location 111 with the service data store 140. The service data store 140 may also associate the service provider with a service state of available, indicating the service provider is available to receive service requests. As the service provider operates their respective vehicle, the service application 106 may continue to transmit the current location 111 of the service provider to the provider device interface 110, and the provider device interface 110 updates the current location of the service provider with the service data store 140.

According to some examples, requesters operate service applications 116 on respective mobile devices 104 to submit service requests 101. Initially, the requesters may launch the service application 116 for a variety of reasons, such as to view information about the current state of the network service, to make a service request, to review service provider availability near the current location of the requester, or to check status of a service request which was previously made. For example, the service application 116 can receive, from the system 100, data about the network service, such as an estimated time of arrival of a particular service type (e.g., service or vehicle offering type) to the request's current location and/or a computed cost for that service type. The service application 116 can display the service data of a service type (or multiple service types concurrently) in a user interface for the requester to view and consider when making a decision on whether to request service. As described with other examples, the service application 116 may provide a user interface that includes service related information, as well as other forms of content (e.g., news, promotional offers, etc.). The requester device interface 120 may receive, for example, a given service request 101 specifying a service start location 103 and destination 105, as well as other parameters such as a service type. When the requester submits the service request 101, the service request may be deemed open until the service request is matched to a service provider. In some variations, the service provider may also be able to cancel a service request 101, subject to one or more rules or conditions. For example, the requester may be able to cancel a service request 101 at any time preceding when a service provider is matched, or within a designated duration of time after making the service request 101. As another example, the requester may cancel the service request subject to a cancellation penalty.

The service monitor 138 includes logic that monitors the service data store 140 for unmatched service requests and matched service requests. The service monitor 138 may detect when, for example, a service request is initiated and completed. Upon such completion, the service monitor 138 triggers an accounting interface 136 to implement an accounting function (e.g., transfer credit from requester account in account store 131 to provider account in account store 132).

The service request 101 may be received by the requester device interface 120 and forwarded to the matching component 130. The matching component 130 implements a selection process to match the service request to a service provider. Once the matching component 130 matches an available service provider to a service request 101 (e.g., the matching component 130 selects a service provider and the service provider accepts service), the matching component 130 may change the state of the service provider from available to assigned. The provider device interface 110 may continue to update the service data store 140 with the current location 111 of the service provider as the service provider travels to the service start location 103 and then to the destination 105. In this way, the system 100 is able to monitor and track different types of service activity for both service provider and requesters.

According to some examples, the system 100 includes a predictive sub-system 150 that can process service signals (e.g., inputs from an operator that reflect a communication, application setting, functionality etc.) to select groups of users who are likely to have a predefined user action or behavior that is in accordance with an objective of the service signal. In selecting the groups of users, the predictive sub-system 150 may utilize input from a variety of sources, including for usage monitors 122, 124 which receive input and/or data from respective mobile devices 102, 104 of providers and requesters (e.g., via the respective service applications 106, 116). The predictive sub-system 150 may also utilize input from the service monitor 138, in order to identify real-time service events affecting individual users and their respective service profiles (e.g., user receives a service transport). The predictive sub-system 150 may also receive input from an account store of individual users, which may include logs (e.g., history of service requests), account information (e.g., service charges) and other service related activity of individual users.

Among other functionality, the predictive sub-system 150 enables an operator to customize functionality and settings of service applications based on a likelihood that the user will have a corresponding intent. As another example, the predictive sub-system 150 can field communications to users in the population with a relatively high conversion rate, as compared to a baseline value.

With reference to FIG. 1B, the user predictive sub-system 150 includes a service profile updater 154, a service signal interface 156, and a model determination 180. The service profile updater 154 may update a usage data store 163 that is maintained and continuously updated for a population of users. The usage data store 163 may include a usage data structure 165 that associates individual users in a population of users, with multiple types of predefined parameters, including, for example, (i) a set of user parameters 167, which characterize information about the user, independent of the user's utilization of the service; (ii) a set of service application parameters 169, which characterize a user's interaction and/or use of the service application 106, 116; and/or (iii) a set of service parameters 171, which characterize a user's utilization of the service (e.g., on-demand transportation service). By way of example, the set of user parameters 167 may include demographic information, including location where individual lives. The set of user parameters 167 may also include information determined from the user's use of the network service, or from third-party sources, such as the user's work address, or frequent destinations of the user.

The set of service application parameters 169 may include parametric values that reflect type, frequency, duration, or pattern of use of activity with respect to the respective service application 106, 116. By way of example, the set of such as when and how often the respective service application is launched, frequency in which the service application is launched and closed without the user requesting service, duration of time between when service application is launched and user requests service, use of service application for secondary features and purposes, such as in-application messaging or viewing content or promotional material and/or duration of time in which the service application is used over the course of a given time period (e.g., a day or a week, etc.). For transportation services, the user interaction with the service application may also reflect a user's preference for a particular type of transport service, reflecting the service interface the user most often generates a request from, or the service type(s) or interface the user spends the most amount of time (or frequency) viewing (e.g., the amount of time information about a particular type of transport service is presented on the user interface of the service application before the user changes the view, changes to view information about another type(s) of transport service, or providers other input, etc.).

The set of service parameters 171 may include parametric values that reflect type of service requested and/or received, as well as frequency in which service is requested and/or received, amount of service received, and pattern with respect to frequency and amount of service received. In the context of transportation services (e.g., on-demand transportation), the amount of service may reflect, for example, distance traveled, trip times and fare values. The service parameters 171 reflecting the amount of service may include aggregate values (e.g., average, median, running or weighted average), reflecting values that encompass one or more intervals (e.g., current day, past week, past month, etc.). In the context of food or grocery delivery, the amount of service requested may include, for example, the amount of food orders placed, size of food orders (e.g., number of persons, overall value), and distance traveled from food provider to user.

The service profile updater 154 updates the user profile data structure 165, using data received from other components of system 100. According to some aspects, the service profile updater 154 receives (or retrieves) profile updates 149 from one or more components of system 100, including from usage monitors 122, 124, and/or account interface 136. According to some examples, the service profile updater 154 detects some types of usage events 155 from real-time device data 123, 125, obtained from usage monitors 122, 124 through the user's respective service application 106, 116. For example, the device data 123, 125 may originate from programmatic processes that run on respective service applications 106, 116 on user devices 102, 104. The programmatic processes may run to detect user activity, such as the user launching the respective service applications 106, 116, and the user interacting with interfaces provided through respective service applications 106, 116 to request or provide service.

In variations, the service profile updater 154 may detect other types of usage events from the service monitor 138, which monitors the service data store 140. For example, the service profile updater 154 may receive real-time (or near real-time) information about a user's service request, the service received or performed by the user, and/or the interaction the user had with respect to the service application or another user.

As an addition or variation, the service profile updater 154 may detect predefined usage events by querying service logs of the active data store, application logs maintained by the respective service applications 106, 116, and profile information maintained by profile or accounting resources of the user. The service profile updater 154 may utilize a library of predefined usage events (e.g., based on syntax in application or service logs, responsive to events generated in real-time from the service data store 140 or respective service application 106, 116, etc.) to detect the occurrence of usage events 155, and to assign value to such usage events based on, for example, contextual information that is detected with or otherwise determined from the usage events 155.

The service signal interface 156 enables definition and/or modification of a service signal 157, as well as one or more intents 159 which are associated with each respective service signal 157. In some examples, service signals 157 may be created by an operator or partner for a variety of purposes (e.g., creating highly-personalized application features and interface, converting offers from the operator or partners, researching refinements to features of the service application or service, etc.). According to some examples, the service signal 157 may be associated with a desired outcome or result, and the optimization (e.g., maximization) of that outcome or result may correspond to the objective of the service signal 157. By way of example, the service signal 157 may represent a service communication (e.g., in-app message), service feature, application setting (e.g., which service type should be automatically selected for which user as a default when the application is launched), application configuration, programmatic trigger, or other facet of the service provided by the system 100 through, for example, the service application 106, 116 and/or received and/or performed by the respective user, for which predictions of a responsive user action or behavior amongst a group of users is desired. The intent(s) 159 of the service objective 157 may be defined to reflect the desired group of users, based on the objective of the service signal 157.

Accordingly, the intent(s) 159 of the service signal 157 represent groupings of users, based on predefined user actions (e.g., user response to a problem or communication, user initiated action) and behaviors (e.g., repeated user-action over an extended period of time). In some variations, the intent(s) 159 that are defined for each service signal 157 may reflect both desirable and undesirable groups of users, with desirable groups of users reflecting one or more groups for which the intent is in accordance with the objective of the service signal 157, and the undesirable groups reflect one or more groups for which the intent is inconsistent or incongruent with the objective of the service signal 157.

According to some examples, the predictive sub-system 150 utilizes models to identify users (or sets of users) who are more likely (e.g., have a propensity) to respond to a service signal 157 in accordance with a predefined intent (e.g., desirable group). In some implementations, the predictive sub-system 150 may utilize models to identify users who are more likely to respond to the service signal 157 with an action or behavior that is contrary to the objective of the service signal 157. As an addition or alternative, individual models may predict a statistically more significant response by type from a group of users within the population, as compared to a random selection of users.

In an example of FIG. 1B, the predictive sub-system 150 includes a model determination 180, which may include model training 182, model evaluation 184, a model library 185, and subject selection component 186. As described in greater detail, the model determination 180 enables training and selection of models for purpose of selecting users that are more likely to satisfy predefined intent(s) 159 of individual service signals 157, which may be received or otherwise specified through the service signal interface 156. The subject selection component 186 may include a process (or set of processes) that queries (or otherwise scans) the user data store 163 for users that have specific characteristic profiles, as identified by a model (or set of models). The subject selection component 186 may, for example, specify characteristic profiles that one or more of (i) the user parameters 167, (ii) the service application parameters 169, and/or (iii) the service parameters 171. For a given service signal 157, the subject selection component 186 may provide the service signal interface 156 with a group of users 179. When a trained model is used to select a group of users (“selected group 183”) from the usage data store 163. As described below, the selected group 183 may collectively have a greater number of users that match the intent 159 of the service signal 157, as compared to a baseline of users. The determination of baseline users may be based on various factors, including, for example, a random selection. The selected group 183 may correspond to a collection of identifiers representing users, such as, for example, unique service identifiers and/or mobile device phone numbers.

The service signal interface 156 may initiate a service action (e.g., communication) that corresponds to the service signal 157 for users that are identified with the selected group 183. In some examples, the service signal 157 is communicated to individual users of the selected group 183, via the respective provider or requester device interface 110, 120. The system 100 may then monitor the respective users for a predefined action or behavior. The system 100 may monitor the respective users via, for example, any one of the programmatic processes on the respective service applications 106, 116, the provider/requester device interface 110, 120, and/or usage monitors 122, 124.

When a subject/user receives a service signal 157 and acts or behaves in a manner that is consistent with a corresponding predefined intent 159, the subject/user may be said to have converted. A conversion rate may be defined as a ratio that accounts for a total number of users who receive a given service signal 157, as compared to a number of those users who act or otherwise exhibit a behavior that is defined by an intent of the service signal 157. For example, the service signal 157 may correspond to a promotional offer that is communicated to a selected group of users. The intent 159 associated with the promotional offer may correspond to users who accept the offer. The conversion rate for the service signal 157 may be based on the total number of users who received the offer and the total number of users who responded to the offer with an acceptance.

According to some examples, the system 100 may monitor the users who receive the service signal 157 to determine feedback, which may be in the form of detecting conversions 177. The service profile updater 154 may, for example, record conversions 177 with the usage data store 163, and the model determination 180 may receive feedback 175 that identifies converted and/or non-converted users for a particular service signal 157. Based on the feedback 175, the model training 182 may parse the individual characteristic parameters of the monitored users/subjects to identify common characteristics amongst those users who acted in accordance with the defined intent 159 (e.g., those users who accepted the promotional offer), as well as those users who did not respond in accordance with the intent 159 (e.g., those users who did not act on the promotional offer, or those users who affirmatively declined the promotion offer). The model training 182 may adjust weights that the utilized model assigns to specific characteristics represented by, for example, user parameters 167, service application parameters 169, and/or service parameters 171. Through monitoring of users who are identified as subjects of a given service signal 157, the model training 182 may tune a given model to (i) identify and favorably weight those usage profile characteristics (as reflected by the user parameters 167, service application parameters 169, and/or service parameters 171) that are the most correlative to a user group of a defined intent 159; and/or (ii) identify and unfavorably weight those usage profile characteristics (as reflected by the user parameters 167, service application parameters 169, and/or service parameters 171) that are correlative to users who did not convert when the service signal 157 was received.

In some examples, the model evaluation 184 may determine a baseline for a service objective by, for example, determining a conversion rate for a given service signal 157 using a random selection of users. As models are trained, the model evaluation 184 may compare the performance of the models (e.g., the conversion rate) to those of the baseline, in order to evaluate the performance of the respective models. The model evaluation 184 may correlate the performance of individual models with service signals 157 (e.g., including defining characteristics and objectives of service signals). In some examples, the model determination 180 may train and utilize multiple models for given service signals 157, in order to identify models that perform best for individual service signals 157.

In some examples, when a new service signal 157 is provided, the model evaluation 184 may compare the characteristics and/or objectives of the newly received service signal 157 with those of previously deployed service signals in order to identify one or more similar models which are likely to perform the best in predicting the groups of users with the respective intent(s). Thus, for example, a similarity comparison can be performed to identify service signals 157 that are similar and thus likely to benefit from use of same models or model types.

Still further, some examples utilize a group of models for individual service signals 157. The selection of the group of models (also referred to as “model ensemble”) may be tuned to, for example, performance based on specific characteristics (as represented by parameters of the usage profile data structure 165) in the user base, as well as other factors such as the geographic region or sub-region and/or the time in which the service signal 157 is deployed. The model evaluation 184 may also correlate objectives of select models to characteristics reflected by the parameters of the usage profile data structure 165 in order to enable model selection and ensemble modeling.

In some examples, the predictive sub-system 150 implements a targeting model that includes determining a baseline group, as well as a conversion rate for the baseline group with respect to a particular service signal 157 and intent 159. The targeting model may develop a treatment model for an alternative group of users which share a predetermined set of profile characteristics. In this manner, the targeting model can be developed to predict the conversion rate of a defined treatment group, where the treatment group includes users with a predetermined set of profile characteristics. By way of example, the specific user profile characteristic of the treatment group may be defined by parametric values of the user profiles, such as by a set of user parameters 167, service application parameters 169, and/or service parameters 171. In some examples, the targeting model can also be developed to predict a conversion rate when a given treatment (as provided by a respective service signal 157 and intent 159) is applied to a particular user group of individuals with a given user profile characteristic (e.g., as defined by user parameters 167, service application parameters 169, and/or service parameters 171).

In some variations, the baseline group can be determined using a separate baseline model. By way of example, the baseline model may predict or otherwise determine a conversion rate that is representative of a larger population of users, while the treatment group may share user profile characteristics which form a subset of the larger population. Once the baseline group of users is determined, the targeting model can predict the difference in conversion rates between a select treatment group of users and the baseline group of users.

In variations, the predictive sub-system 150 can implement a user response model which implements separate models to determine the baseline group, as well as one or multiple treatment groups (e.g., users with alternative characteristics, as defined by parametric value of the respective user profiles). Thus, for example, the user response model can deploy a baseline model on a baseline group of users to predict a conversion rate amongst the baseline set of users. At the same time, one or multiple treatment models may be deployed on alternative treatment groups to predict the conversion rate of specific treatment groups. The conversion rate of one or more multiple treatment groups, as predicted by one or more multiple models, can be compared to the conversion rate of a baseline group, as predicted by a separate baseline model. Thus, the user response model may implement the respective baseline and treatment group models in parallel, and predicted conversion rates of the treatment groups can be compared to those of the baseline group in order to evaluate the respective models. Still further, when a model is developed that is effective for a service signal 157 and intent 159, the particular model may be used to determine the baseline group from which the targeting model may be updated, refined or modified. Over time, increasingly effective baseline models may be determined and associated with characteristics of service signals 157 and/or intents 159 on which the models were deployed and evaluated. For development of a new or updated targeting model, the determination of the baseline group may include matching characteristics of the target service signal 157 and/or intent 159 with a prior model that was deemed effective for determining a treatment group for a similar service signal and/or intent.

As another example, an intent model may be used to identify a group of users that have an intent that is highly predictive of a target action. For example, an intent model may identify users who have a propensity to interact with a notification feature (e.g., a notification feature to request notification when a particular product or service is available). In such an example, the intent model may be used to identify a limited number of users who have a propensity to select a notification feature, as the propensity may be deemed to be highly correlative to users who would use the feature to order a product or service at a given time when prompted. In situations where the objective sought from the intent model is subject to a quote (e.g., offer promotion to 500 users), the intent model can identify a group of users (e.g., 1000 users) with the propensity to interact with the notification feature in order to efficiently identify a group of users who will request the product or service without exceeding the quota.

Still further, in some variations, the predictive sub-system 150 may deploy an uplift tree model, which can utilize machine learning techniques of random forest and uplift modeling to predict when a particular treatment (or service signal 157) yields incremental demand. In such examples, the models may be trained on training data that is split based on a determination of user action that defines incremental demand (e.g., users who will take a particular action as compared to users who will not, given a particular service signal 157).

In some variations, the predictive sub-system 150 may be implemented for simulation. For example, the service signal 157 may correspond to a new or modified functionality. The predictive sub-system 150 may correlate the service signal 157 to other service signals in order to predict, for example, a favorability of the feature when deployed to users in the population.

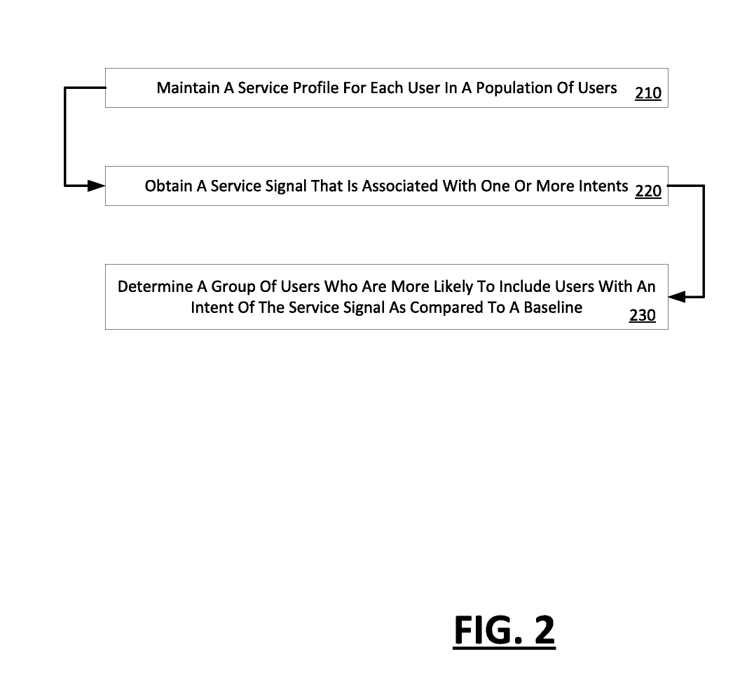

FIG. 2 illustrates an example method for implementing a predictive system to select groups of users with greater propensity for a particular intent. In describing an example of FIG. 2, reference may be made to examples of FIG. 1A and FIG. 1B, for purpose of illustrating suitable components and functionality for performing a step or sub-step being described.

With reference to an example of FIG. 2, a service profile is maintained for each user in a population of users (210). For example, a user profile may associate the user with numerous parameters that correlate to characteristics of the user with respect to the user's utilization of a service (e.g., on-demand transportation).

For example, the service profile of the user may identify parameters that correlate to usage event such as a number of instances in prior time intervals, during which the user requested or received a particular type of service. In the context of on-demand transportation, the service profile may also include parameters that correlate to a number of trips the user received or requested in the previous week, previous month, previous three months, etc. The parameters may also correlate to an amount or quantity with respect to service received, such as the distance traveled, time during which service was received, cost for service etc. The parameters may also include aggregations of the stated amounts, such as by average, medium, running average etc. As additional examples, the characteristics of the user with respect to the utilization of the service may also include a duration since the user's prior use of the service (e.g., number of days since the user last requested service).

Additionally, the characteristics of the user service profile may also include parameters that correlate to the user's interaction with a service application and/or mobile device. For example, the service profile of the user may identify usage events leading to the interaction of the user with respect to the service application, including parameters that correlate to a number of instances in which the service application is launched, a time interval during which the service application remains running on the user's mobile device, an activity the user performs with respect to this service application, other than request or receive service (e.g., view in-application service messages, provide feedback for a service provider).

In some variations, the service profile of the user may also include parameters that are correlative to information about the user that is independent of the service. For example, the user's service profile may maintain information about the user's gender, age, sub-region of residence and other demographic information.

According to some examples, a service signal may be obtained having one or more predefined intent(s) (220). By way of example, the service signal may correspond to any one of (i) a communication transmitted from a service to the user (e.g., a promotional offer provided through email or text message), (ii) a notification message provided to the user via the service application (e.g., in-app message), (iii) a default setting for the user's service application (e.g., content of service application's home screen, preferred service interface and service type), and/or (iv) an instruction carried out on behalf of the user (e.g., order a particular type of service for the user by default). Each of the service signals may be associated with an intent, representing a predefined action or behavior of a user that is being sought as a response to the service signal 157. For example, an intent for a service offer may correspond to a user action that accepts the service offer. Similarly, a service signal corresponding to an application setting in which a request interface for a service type, such as a luxury service, is provided by default may correspond to a user action in which the user makes a service request from the request interface of the luxury service.

According to some examples, the predictive sub-system 150 identifies a group of users that will have a relatively larger portion of users with the intent of the service signal 157 (230). In other words, an identified group of users are likely to include more users that are to perform an action in accordance with the intent of the service signal, as compared to a baseline value (e.g., determined from random sample of users).

As examples, the predictive sub-system 150 may be used to customize a user's experience with regards to utilization of the service (e.g., on-demand transportation) and/or service application, based on the user's service profile. The customization may, for example, be based on correlations that are determined from past user actions (e.g., past user instances when luxury service was requested), as well as from inferences that are predictively determined based on the user's service profile. Thus, for example, a model may use the user's service profile to predict that the user will not always want to request luxury service, but may do so when luxury service is pragmatic (e.g., when the user is in a particular sub-region). As another example, the model may predict that the user will prefer a non-luxury service to a luxury service in order to use a discount offer for the non-luxury service. In such an example, the predictive sub-system 150 may model for user responses and behaviors to service signals 157 based on the individual user service profiles.

As another example, the service signal 157 may identify an offer for a subscription product by which a user may receive service at a flat or discount rate. The service signal 157 may include multiple intents, representing each of (i) a user action of accepting the service offer, (ii) a user behavior of utilizing the service in accordance with a pattern that maximizes a benefit of the offer; and/or (iii) a user behavior of utilizing the service in accordance with a pattern that is less than optimal (e.g., user is penalized for overuse) but still beneficial for the user.

In some examples, different models may also be used to identify groups of users with each of the identified intents. Sill further, in some examples, an ensemble model may be used to identify users of each intent.

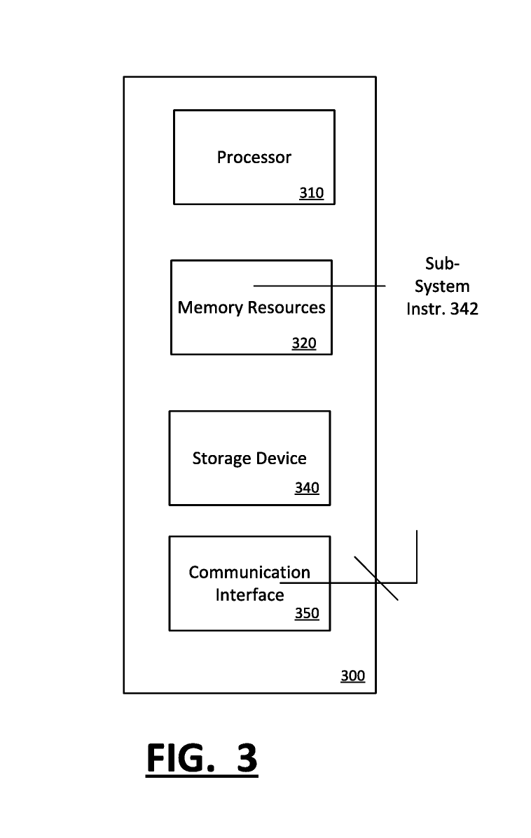

FIG.3 is a block diagram that illustrates a computer system upon which embodiments described herein may be implemented. A computer system 300 can be implemented on, for example, a server or combination of servers. For example, the computer system 300 may be implemented as part of a network service for providing transport services.

In one implementation, the computer system 300 includes processing resources 310, memory resources 320 (e.g., read-only memory (ROM) or random access memory (RAM)), a storage device 340, and a communication interface 350. The computer system 300 includes at least one processor 310 for processing information stored in the memory resources 320, such as provided by a main memory. As an addition or alternative, the memory resources 320 may include a random access memory (RAM) or other dynamic storage device, to store information and instructions which are executable by the processor 310. The memory resources 320 may also store temporary variables or other intermediate information during execution of instructions to be executed by the processor 310. The computer system 300 may also include the memory resources 320 or other static storage device for storing static information and instructions for the processor 310. A storage device(s) 340, such as a magnetic disk or optical disk, is provided for storing information and instructions for implementing the system 100, such as described herein.

The communication interface 350 enables the computer system 300 to communicate with one or more networks (e.g., cellular network) through use of the network link (wireless or a wire). Using the network link, the computer system 300 can communicate with one or more computing devices, and one or more servers. In accordance with examples, the computer system 300 receives provider information from the mobile computing device of individual providers.

The processor 310 may be configured with software and/or other logic to perform one or more processes, steps and other functions described with implementations, such as described by the predictive sub-system 150. Examples described herein are related to the use of the computer system 300 for implementing the techniques described herein. According to an aspect, techniques described herein are performed by the computer system 300 in response to the processor 310 executing one or more sequences of one or more instructions (sub-system instructions 342) contained in the main memory 320. Such instructions may be read into the main memory 320 from another machine-readable medium, such as the storage device 340. Execution of the sequences of instructions contained in the main memory 320 causes the processor 310 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

What is claimed is:

1. A computer system comprising:
one or more processors;
a set of memory resources to store a set of instructions;
wherein the one or more processors use the set of instructions to:
maintain a service profile for each user in a population of users of a network service, the service profile identifying a plurality of service parameters, and each service parameter of the service profile being based at least in part on one or more predefined usage events;
wherein for each user, the one or more processors maintain the service profile by:
(i) monitoring the user in connection with the respective user's utilization of the network service, the network service being implemented in part through use of a service application that runs on a mobile device of the respective user;
(ii) detecting, from monitoring, multiple different usage events;
(iii) updating the service profile of the respective user with respect to one or more service parameters that are based at least in part on the detected usage events;
identify, a service signal, the service signal identifying an intent for a group of users; and
determine, using the updated service profile of individual users of the population, a group of users that is likely to include more users that are to perform an action in accordance with the intent of the service signal, as compared to a baseline value.

2. The computer system of claim 1, wherein the one or more processors determine the group of users using a model.

3. The computer system of claim 2, wherein the one or more processors train the model by triggering a service signal for a service objective on the mobile device of a random selection of users, and then monitoring individual users in the random selection for an activity that is correlative to at least one of (i) the user performing a predetermined action, and/or (ii) the user not performing the predetermined action.

4. The computer system of claim 3, wherein the one or more processors determine the model based on one or more characteristics of the service signal.

5. The computer system of claim 1, wherein the one or more processors determine the group of users using an ensemble of models.

6. The computer system of claim 1, wherein the one or more processors determine the group of users using a targeting model that utilizes a baseline group.

7. The computer system of claim 6, wherein the one or more processors utilize a different model to determine the baseline group.

8. The computer system of claim 1, wherein the one or more processors determine the group of users using an uplift tree model.

9. The computer system of claim 1, wherein the one or more processors determine the group of users using an intent model.

10. The computer system of claim 1, wherein the service signal corresponds to a service offer, and wherein the intent is characterized by a user action of responding to the service offer with an action that reflects an acceptance of the service offer.

11. The computer system of claim 1, wherein the service signal corresponds to a request interface provided through the service application for a particular type of service, and wherein the intent is characterized by a user action of requesting the particular type of service using the request interface, without viewing an alternative type of service that is available through the service application.

12. The computer system of claim 1, the service signal corresponds to is a content prompt provided through the service application, and wherein the intent is characterized by a user action of selecting to view a content of the content prompt through interaction with the service application.

13. The computer system of claim 1, wherein the one or more processors update the one or more service parameters to reflect a value that is based on contextual information that is associated with each usage event.

14. The computer system of claim 1, wherein the one or more processors update the one or more service parameters to reflect a value for a parameter that reflects a service request count of the user over a prior duration.

15. The computer system of claim 1, wherein the one or more processors update the one or more service parameters to reflect a value representing an aggregation of a duration in time or distance over a prior interval of time.

16. The computer system of claim 1, wherein the one or more processors update the one or more service parameters to reflect a measure of time since a prior service request.

17. The computer system of claim 1, wherein the baseline value corresponds to a random selection of users from the population of users.

18. A method for providing a network service, the method being implemented by one or more processors of a network computer system and comprising:
maintaining a service profile for each user in a population of users, the service profile identifying a plurality of service parameters, and each service parameter of the service profile being based at least in part on one or more predefined usage events;
identifying a service signal in connection with providing the network service, the service signal identifying an intent for a group of users; and
determining, using the updated service profile of individual users of the population, a group of users that is likely to include more users that are to perform an action in accordance with the intent of the service signal, as compared to a baseline value.

19. The method of claim 18, wherein maintaining the service profile includes:
monitoring the user in connection with the respective user's utilization of the network service, the network service being implemented in part through use of a service application that runs on a mobile device of the respective user;
detecting, from monitoring, multiple different usage events; and
updating the service profile of the respective user with respect to one or more service parameters that are based at least in part on the detected usage events.

20. The method of claim 18, wherein determining the group of user includes using a model, and wherein the method further comprises:
training the model by triggering a service signal for the service objective on the mobile device of a random selection of users, and then monitoring individual users in the random selection for an activity that is correlative to at least one of (i) the user performing a predetermined action, and/or (ii) the user not performing the predetermined action.

21. The method of claim 20, wherein determining the model is based on one or more characteristics of the service signal.

22. A non-transitory computer-readable medium that stores instructions, which when executed by one or more processors of a network computer system, cause the network computer system to perform operations that include:
maintaining a service profile for each user in a population of users, the service profile identifying a plurality of service parameters, and each service parameter of the service profile being based at least in part on one or more predefined usage events;
identifying a service signal in connection with providing a network service, the service signal identifying an intent for a group of users; and
determining, using the updated service profile of individual users of the population, a group of users that is likely to include more users that are to perform an action in accordance with the intent of the service signal, as compared to a baseline value.
